(19) United States
(12) Patent Application Publication
(10) Pub. No.: US 2007/0016315 A1
(43) Pub. Date: Jan. 18, 2007

(54) Portable digital music playback device

(76) Inventors: Alger Yang, Jubei City (TW); Vincent Lo, Jubei City (TW); Jevons Lin, Jubei City (TW); Jeff Chang, Jubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/181,936

(22) Filed: Jul. 15, 2005

(51) Int. Cl. G06F 17/00

(52) U.S. Cl. 700/94

(57) ABSTRACT

A portable digital music playback device integrates a digital music walkman connection interface, a power supply unit, a data transmission interface and a multi-channel loudspeaker together. The portable digital music playback device is used to connect a digital music walkman, to play music, to transmit data, and to perform charging actions. Through a multi-channel design, a better sound quality of played music can be achieved. Moreover, because several transmission interfaces are integrated together, more convenient operations can be accomplished for users.

### BACKGROUND OF THE INVENTION

1. Field of the Invention

The present invention relates to a playback device and, more particularly, to a digital music playback device that is portable, can be charged, and can transmit data.

2. Description of Related art

Along with the progress of science and technology, the functions of digital science and technology products multiply. They have miniaturized core devices, and the sizes of their peripheral accessories are shrunk synchronously. The science and technology products are made more and more compact to facilitate mobility and portability.

Among various science and technology products, Apple's iPods are the most fashionable music players today, and have promoted hot sale of peripheral goods. According to the statistics of Season 1, 2005, the sale of various Apple computer hardware including iMac first breaks through one million. When the iPod is being charged, one cannot take it along to listen to music. In using iPod, one needs to use an earphone to listen to music. iPod cannot be used play music in front of the public. It is necessary to connect a loudspeaker for sharing of music. There are no existent devices that can simultaneously integrate the charging, portability, and playback functions of iPod.

### SUMMARY OF THE INVENTION

An object of the present invention is to provide a portable digital music playback device, which integrates a charging seat, an audio amplifier, and a data transmission interface to let a digital music walkman simultaneously have multiple functions such as charging, music playback, and data transmission.

Another object of the present invention is to provide a portable digital music playback device to make the sound quality of played music better through a multi-channel design and especially the design of a bass air duct.

Another object of the present invention is to provide a portable digital music playback device, which integrates several transmission interfaces together to facilitate operation for users.

According to the present invention, a portable digital music playback device, comprises a digital music walkman connection interface, at least three loudspeakers, a power supply unit and a data transmission interface. The digital music walkman connection interface is connected to a digital music walkman. The digital music walkman connection interface is connected to an audio output unit. The audio output unit is connected to the loudspeakers for playback of digital music data. The loudspeakers are of 2.1 sound channels and have a bass air duct. The data transmission interface is also connected to the digital music walkman connection interface so that the digital music walkman can mutually transmit digital music data with a computer. The power supply unit provides electricity for charging of the digital music walkman and playback of digital music data.

### BRIEF DESCRIPTION OF THE DRAWINGS

The various objects and advantages of the present invention will be more readily understood from the following detailed description when read in conjunction with the appended drawing, in which:

FIG. 1 is a perspective view of the present invention;

FIG. 2 is a rear side view of the present invention; and

FIG. 3 is a block structure diagram of the present invention.

### DETAILED DESCRIPTION OF THE PREFERRED EMBODIMENTS

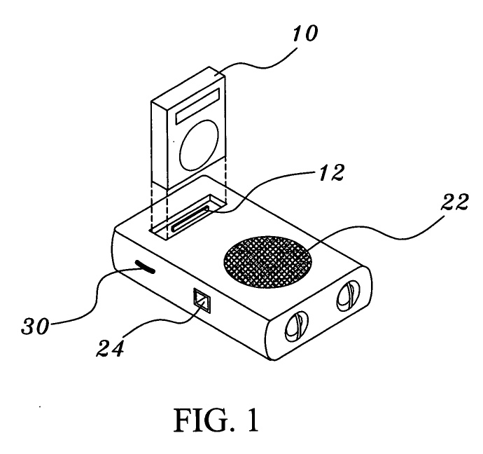

As shown in FIG. 1, a portable digital music playback device of the present invention provides playback, charging and data transmission for a digital music walkman 10. The digital music walkman 10 is an iPod or an MP3 player.

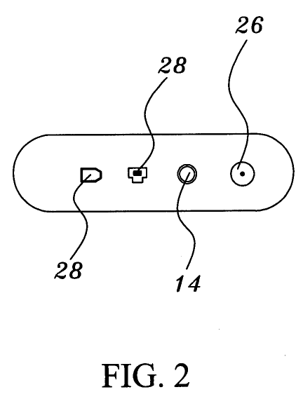

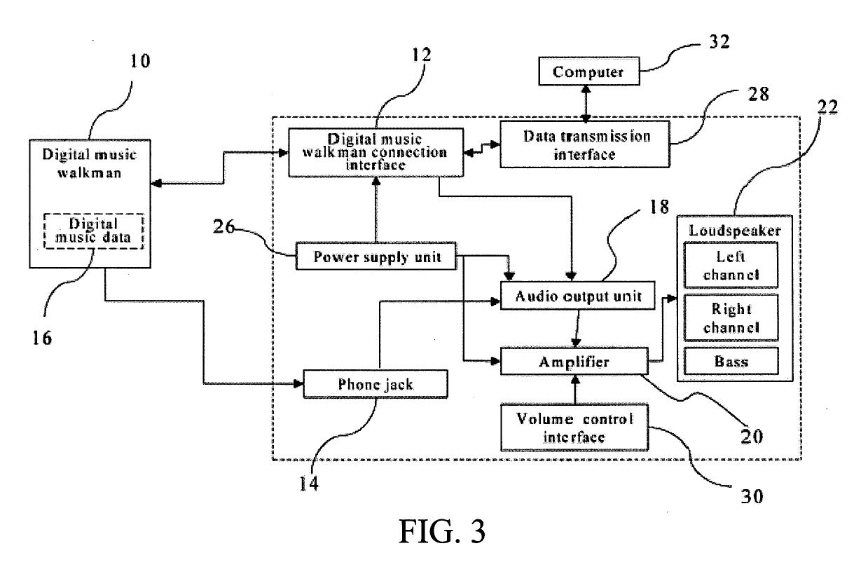

As shown in FIGS. 1 to 3, the portable digital music playback device has a digital music walkman connection interface 12 and an audio input interface 14 for connecting the digital music walkmans 10. The audio input interface 14 is a phone jack. The digital music walkman connection interface 12 and the audio input interface 14 are connected to the digital music walkman 10. Digital music data 16 in the digital music walkman 10 are read and then output to an audio output unit 18. The audio output unit 18 is connected to an amplifier 20. Audio lines of 2.1 sound channels are connected with three corresponding loudspeakers 22. The three loudspeakers 22 are a left channel, a right channel, and a bass, respectively. The bass loudspeaker has an air duct 24 to have more powerful bass. The music playback device has also a power supply unit 26, a data transmission interface 28 and a Volume control interface 30. The power supply unit 26 can provide electricity for charging of the digital music walkman 10 and playback of the digital music data 16. The power supply unit 26 is a plug-input power supply or a battery-input power supply. The data transmission interface 28 is connected to the digital music walkman connection interface 12 to connect the digital music walkman 10 with a computer 32 for transmission of the digital music data 16. The data transmission interface 28 is a USB interface or a 1394 interface. The Volume control interface 30 can control the playback volume of the music playback device.

The present invention integrates a charging seat, an audio amplifier and a data transmission interface together to let the digital music walkman 10 have multiple functions such as charging, music playback and data transmission. Moreover, because several transmission interfaces are integrated together, more convenient operations can be accomplished for users. Through a multi-channel design and especially the design of the bass air duct 24, a better sound quality of played music can be achieved.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A portable digital music playback device providing playback, charging and data transmission for a digital music walkman, said portable digital music playback device comprising:
a digital music walkman connection interface connected to said digital music walkman and used to read and then output digital music data in said digital music walkman to an audio output unit;
at least three loudspeakers being of 2.1 sound channels and having a bass air duct, said loudspeakers being connected to said audio output unit via audio lines to play said digital music data;
a power supply unit providing electricity for charging of said digital music walkman and playback of said digital music data; and
a data transmission interface connected to said digital music walkman connection interface to connect said digital music walkman with a computer for transmitting said digital music data.

2. The portable digital music playback device as claimed in claim 1 further comprising an audio input interface for input playback of a non-serial walkman.

3. The portable digital music playback device as claimed in claim 2, wherein said audio input interface is a phone jack.

4. The portable digital music playback device as claimed in claim 1, wherein said digital music walkman connection interface is an iPod interface.

5. The portable digital music playback device as claimed in claim 1 further comprising a Volume control interface used to control the playback volume.

6. The portable digital music playback device as claimed in claim 1, wherein said power supply unit is a plug-input power supply or at least a battery-input power supply.

7. The portable digital music playback device as claimed in claim 1, wherein said digital music walkman is an iPod or an MP3 player.

8. The portable digital music playback device as claimed in claim 1, wherein said data transmission interface is a USB interface or a 1394 interface.

9. The portable digital music playback device as claimed in claim 1, wherein said an amplifier is disposed between said loudspeakers and said audio output unit.
